(19) United States
(12) Patent Application Publication
(10) Pub. No.: US 2006/0156327 A1
(43) Pub. Date: Jul. 13, 2006

(54) Method for tracking time spent interacting with different remote controlled media devices

(76) Inventor: Blaine H. Dolph, Western Springs, IL (US)

Correspondence Address: DILLON & YUDELL LLP, 8911 N. CAPITAL OF TEXAS HWY.,, SUITE 2110, AUSTIN, TX, 78759, US

(21) Appl. No.: 11/032,873

(22) Filed: Jan. 11, 2005

(51) Int. Cl. H04H 9/00; H04N 5/44; G06F 3/00; G06F 13/00; H04N 7/16; H04N 5/445

(52) U.S. Cl. 725/14; 725/38; 348/734; 725/9; 725/15

(57) ABSTRACT

A method, universal remote controller (URC), and computer program product that enables the tracking, recording, and reporting of the amount of time spent interacting with different media devices with the URC. The URC is enhanced with additional hardware and software components that provide the associated functionality of tracking the time that a user interacts (via the URC) with each media device. The combined hardware and software components utilities complete the following functional operations: (1) stopping and starting one or more timers as a user interacts in pre-defined ways with the media devices (e.g., turning the device on and off); (2) storing the usage times recorded on the respective timers; and (3) compiling and transmitting the data to a computer system for analysis. A computer system is utilized to complete the analysis and reporting of the time usage data.

### BACKGROUND OF THE INVENTION

1. Technical Field

The present invention relates generally to remote control interactions, and in particular to tracking remote control interactions with media devices. Still more particularly, the present invention relates to a method and controller for computerized tracking of remote controlled interactions with media devices.

2. Description of the Related Art

In today's media-rich environment, people spend a considerable amount of time interacting (listening, viewing, etc.) with media devices. Among these media devices, some of the more common devices are the television (TV), stereo player, and DVD/CD players.

In order to provide quick and easy interaction with these media devices, the industry has designed universal remote controllers (URCs) that are capable of controlling multiple, different media devices. Thus, for example, a single URC may control each of the aforementioned media devices (TV, stereo and DVD/CD player). URCs are increasing in complexity as more and more media devices having more advanced features are controlled by the single controller.

Most modern homes are now equipped with these media devices and at least one URC to control multiple of these media devices. With the increasing use of these media devices, particularly in the home, there is occasionally a need to determine the amount of time that is spent interacting with particular media devices. There is currently no way to determine how much time is spent interacting without looking at a clock and recording the time for each device mentally or on paper, etc. While all the media devices may be controlled in some way by a single URC, there is currently no way to efficiently capture, process, and analyze this usage information via actual measurement of the on/off sequencing of these media devices.

### SUMMARY OF THE INVENTION

Disclosed are a method, a universal remote controller (URC), and a computer program product that enables the tracking, recording, and reporting of the amount of time spent interacting with different media devices with the URC. The URC is enhanced with additional hardware and software components that provide the associated functionality of tracking the time that a user interacts (via the URC) with each media device. The additional hardware components include a tracking on/off button and a transmit button and the software components includes usage time tracking utility (UTU) and usage time data transmission utility (UDTU) embedded within the URC. These software utilities complete the following functional operations: (1) stopping and starting one or more timers as a user interacts in pre-defined ways with the media devices (e.g., turning the device on and off); (2) storing the usage times recorded on the respective timers; and (3) compiling and transmitting the data to a computer system for analysis.

The embedded software utility may also record the time spent at specific channels on a multi-channel media device (e.g., a television). Thus, as a user changes from one channel to another on the media device, the software utility records the specific channels along with the amount of time spent at each specific channel. In one embodiment, the specific start time for interacting at the channel and/or with the media device is also recorded.

In addition to the URC, which provides the tracking and recording features of the invention, a computer system is utilized to complete the analysis and reporting of the time usage data. The computer system includes a data receiving device by which the computer system receives wireless (or wired) signals from the URC containing the recorded usage time data. The computer system also includes a data analysis and reporting utility (DARU) for analyzing and generating a report of the usage time data received from the URC. The generated report may be saved to the computer system or transmitted to a different collection point via a computer network.

The above as well as additional objectives, functions, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1A is a block diagram illustrating the media-rich environment within which a universal remote controller (URC) is utilized to control several media devices, according to one embodiment of the invention;

FIG. 1B illustrates an exemplary URC with additional buttons utilized for activating and programming the usage time tracking features of the invention, according to one embodiment;

FIG. 2 is a block diagram illustrating the transfer of data from the universal remote to a computer system in accordance with one embodiment of the invention;

FIG. 3 is a block diagram illustrating the main components of a computer system within which the data analysis and report generating features of the present invention may advantageously be implemented;

FIG. 4 is a flow chart illustrating the process by which user interaction with the different media devices are timed via the URC's usage time tracking feature, according to one embodiment of the invention; and

FIG. 5 is a flow chart illustrating the processing by the computer system of the usage time data received from the URC according to one embodiment of the invention.

### DETAILED DESCRIPTION OF AN ILLUSTRATIVE EMBODIMENT

The present invention provides a method, a universal remote controller (URC), and a computer program product that enables the tracking, recording, and reporting of the amount of time spent interacting with different media devices with the URC. The URC is enhanced with additional hardware and software components that provide the associated functionality of tracking the time that a user interacts (via the URC) with each media device. The additional hardware components include a tracking on/off button and a transmit button and the software components includes usage time tracking utility (UTU) and usage time data transmission utility (UDTU) embedded within the URC. These software utilities complete the following functional operations: (1) stopping and starting one or more timers as a user interacts in pre-defined ways with the media devices (e.g., turning the device on and off); (2) storing the usage times recorded on the respective timers; and (3) compiling and transmitting the data to a computer system for analysis.

The embedded software utility may also record the time spent at specific channels on a multi-channel media device (e.g., a television). Thus, as a user changes from one channel to another on the media device, the software utility records the specific channels along with the amount of time spent at each specific channel. In one embodiment, the specific start time for interacting at the channel and/or with the media device is also recorded.

In addition to the URC, which provides the tracking and recording features of the invention, a computer system is utilized to complete the analysis and reporting of the time usage data. The computer system includes a data receiving device by which the computer system receives wireless (or wired) signals from the URC containing the recorded usage time data. The computer system also includes a data analysis and reporting utility (DARU) for analyzing and generating a report of the usage time data received from the URC. The generated report may be saved to the computer system or transmitted to a different collection point via a computer network.

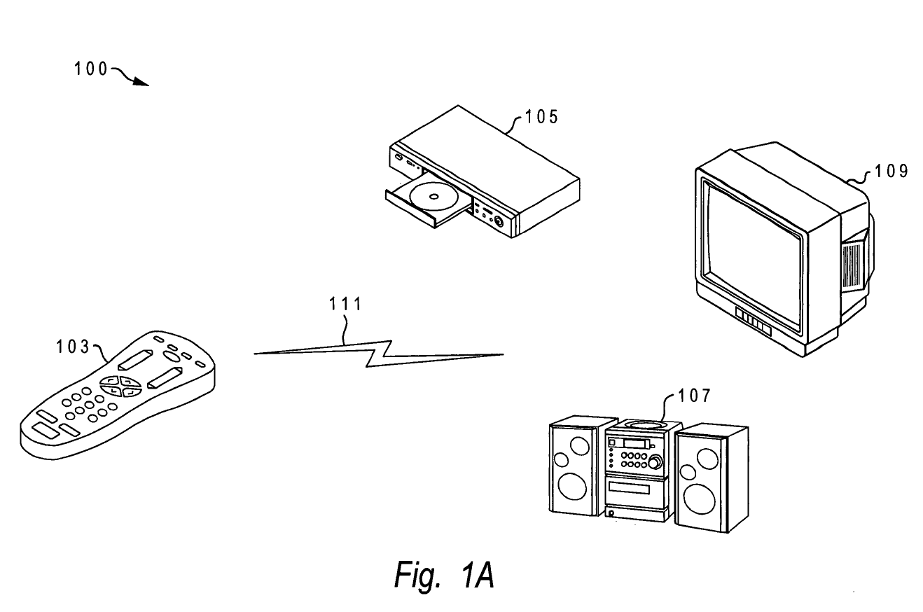

With reference now to the figures, and in particular to FIG. 1A, there is illustrated an exemplary media-rich environment with multiple media devices. The media-rich environment may be a home or some other environment within which a single URC is utilized to operate/control multiple media devices. As shown in FIG. 1A, media devices include television 109, stereo 107, and DVD player 105. Also shown is URC 103 which controls and/or communicates with each of the illustrated media devices via wireless signal 111. As described below, URC 103 has enhanced functionality for tracking usage time during remote interactions with the media devices. For purposes of illustration, only the specific media devices of FIG. 1 are described within the invention. However, it is understood that any number of different types of media devices may be utilized as long as the media devices are being controlled by a URC 103 designed with enhanced usage time tracking components and/or features.

FIG. 1B illustrates an exemplary URC utilized to provide the usage time tracking features of the invention. URC 103 includes a number of buttons utilized to activate/deactivate various functions on the media device(s) being controlled. Among these buttons are the top level power buttons 112 that enables the particular media device to be turned on or off. Below the power buttons 112 are the channels and volume control buttons 114, which enable increase or decrease in the device's channels and device volume, respectively. Feature and selected buttons 116 provides specific features for the device, and number buttons 118, common to most URCs are utilized for channel selection and code entry, etc. URC 103 is also designed with an infrared (or other type) transmitter 126 by which URC 103 transmits infrared signals to the media devices being controlled.

It addition to these conventional buttons (and/or associated functionality), several additional usage time tracking buttons are provided on URC 103 to enable the user to turn on and turn off the time tracking features of the invention. Among these usage time tracking buttons are timer-on button 120 and timer off button 122. These buttons may be utilized in conjunction with an access code that is programmed by the primary user of URC 103. This combination of buttons enables a primary user (e.g., a parent) to turn on the usage time tracking feature with a secure code and activate a background tracking of remote controller interactions (by users, such as the parent's children) with media devices via URC 103. For example, to turn the tracking feature on, the parent may simultaneously press the timer on button 120 and enter a three digit access code. The access code is also utilized to prevent another user from turning the tracking feature off. It should be noted that a single button may be utilized to provide both the timer on/off functions, and the two button embodiment is provided for illustration only.

The functional features associated with the various buttons are programmed as embedded software packages or software utilities on the controller chip located within the URC 103. Associated with the controller chip is a temporary storage facility (e.g., memory card) that is utilized to store the usage time data until the data is transmitted and/or erased.

According to the illustrative embodiment, URC 103 also includes a transmit button 124 and an infrared (or other type) transmitter 126. Transmit button 124 is utilized to initiate a transmission of stored usage time data to a remote computer system. The transmission of usage time data as well as normal remote operation is completed via infrared (or other type) transmitter 126.

In one alternate embodiment, the usage time data is automatically transmitted at pre-established periods. For example, usage time data transmissions may be scheduled for a specific time each day. In this alternate embodiment, user activation of transmit button 124 is not required. However, the user may override/preempt this automatic transmission by pressing the transmit button before the scheduled period. In one embodiment, wired transmission of usage time data is initiated whenever the URC is placed on a base device that is directly connected to the computer system. This embodiment is applicable to URCs that are designed with connector pins/head for electronically coupling URC to connector pins of the base device, or vice versa. Once data is successfully transmitted from the URC, the data is deleted from URC memory. Archiving and analyzing the usage time data occurs on computer system 300, as described below.

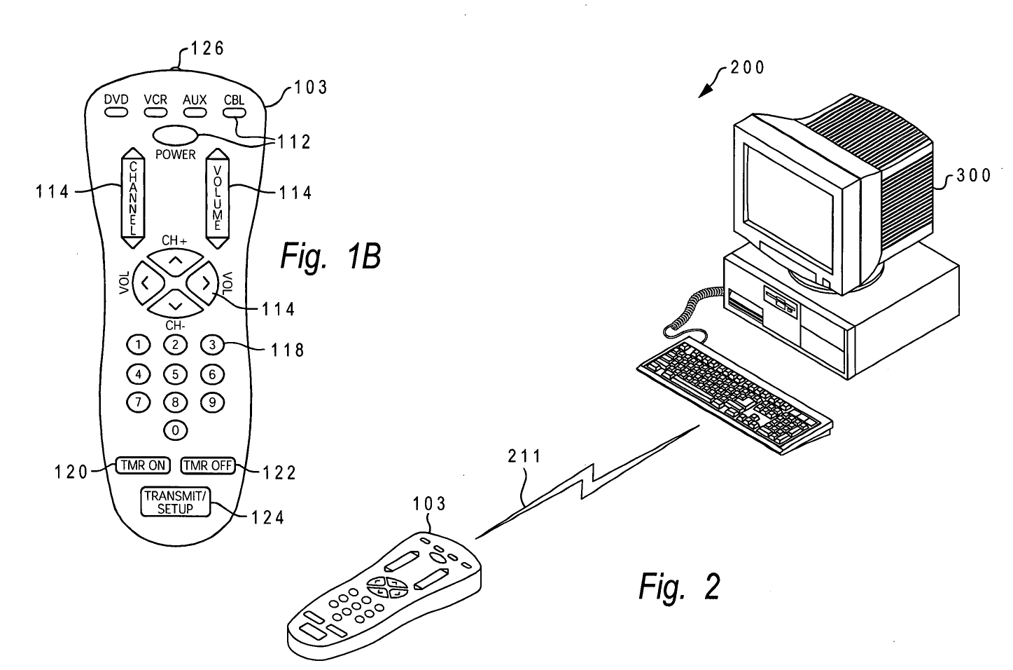

FIG. 2 illustrates URC 103 transmitting wireless signals 211 to computer system 300. The area 200 within which the transmission occurs may be adjacent to or the same as media-rich environment 100 (e.g., a home), with computer system 300 being located within range of the transmitted signal. Computer system 300 may be a desktop, laptop, PDA, etc.

According to one embodiment, infrared transmitter 126 is utilized to transmit usage time data as an infrared signal that is received by a corresponding infrared receiver, as described below. The range for transmitting these infrared signals is dependent on a number of factors. However, some conventional URCs are able to transmit infrared signals to distances greater than a hundred feet. Other transmission mechanisms are possible. For example, microwave transmission or radio frequency (RF) transmission may be utilized to transmit the time usage data. Also, more advanced URCs and/or other devices that are programmed to operate as URCs (e.g., cell phones and personal digital assistants (PDAs)) may utilize WiFi, Bluetooth, 802.11g/a/b, and expanded Bluetooth (operating in ultra-wide band frequency).

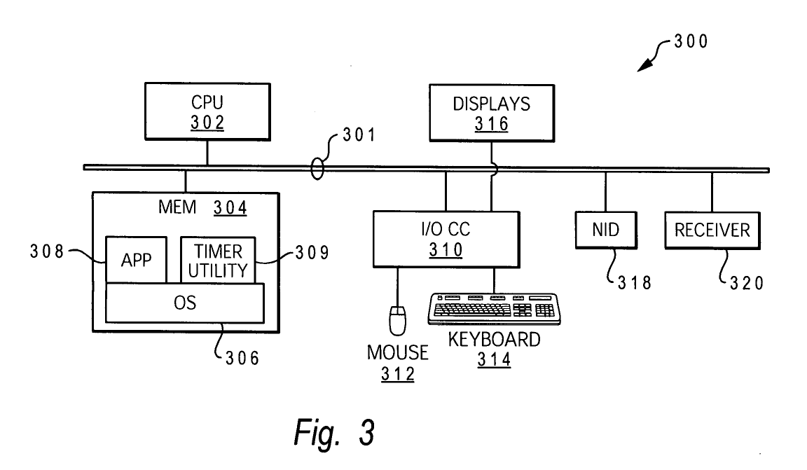

FIG. 3 illustrates an exemplary computer system within which the processing of the usage time data may be completed. Computer system 300 includes a central processing unit (CPU) 302 connected to memory 304 and Input/Output Channel Controller (I/OCC) 310 via a system bus 301. Connected to I/OCC 310 are several input and output devices of which mouse 312, keyboard, 314 and monitor 316 are illustrated.

Illustrated within memory 304 are operating system (OS) 306, application program 308, and usage time analysis and reporting utility (TAR,U) 309. TARU 309 is an application program that completes all of the analysis, compilation/tabulation, and reporting functions on the usage time data received, as further described below.

Computer system 300 also includes a network interface device (NID) 318 and a wireless receiver 320. NID 318 may be utilized to transmit the received and/or processed usage time data to another device (e.g., central server, network computer, administrator/parent's email inbox via the internet, etc.). Wireless receiver 320 is utilized to receive time usage data being wireless transmitted by the URC 103. In one implementation, wireless receiver 320 is an externally located USB-connected device that is packaged with UTARU 309 and sold as a “feature-add” for the URC 103.

Further, in one embodiment, wireless receiver 320 includes a temporary storage facility that allows transmitted usage time data to be stored until the data is forwarded to TARU 309. If computer system 300 is initially turned off, the usage time data is stored and then immediately forwarded to TARU 309 for processing as soon as computer system 300 is turned back on. Successfully transmitting data from URC 103 to computer system 300 is therefore not dependent on the computer system being actually on.

While URC 103 and computer system 300 are illustrated with specific hardware configuration and software components, the invention is applicable to any type of URC designed to track and store the usage time data of multiple media devices (and/or time spent at specific channels of media devices). The invention is further applicable to any computer system capable of receiving and processing wireless signals comprised of usage time data. No structural or operational limitations are implied by the specific configurations and descriptions of these components within the present specification.

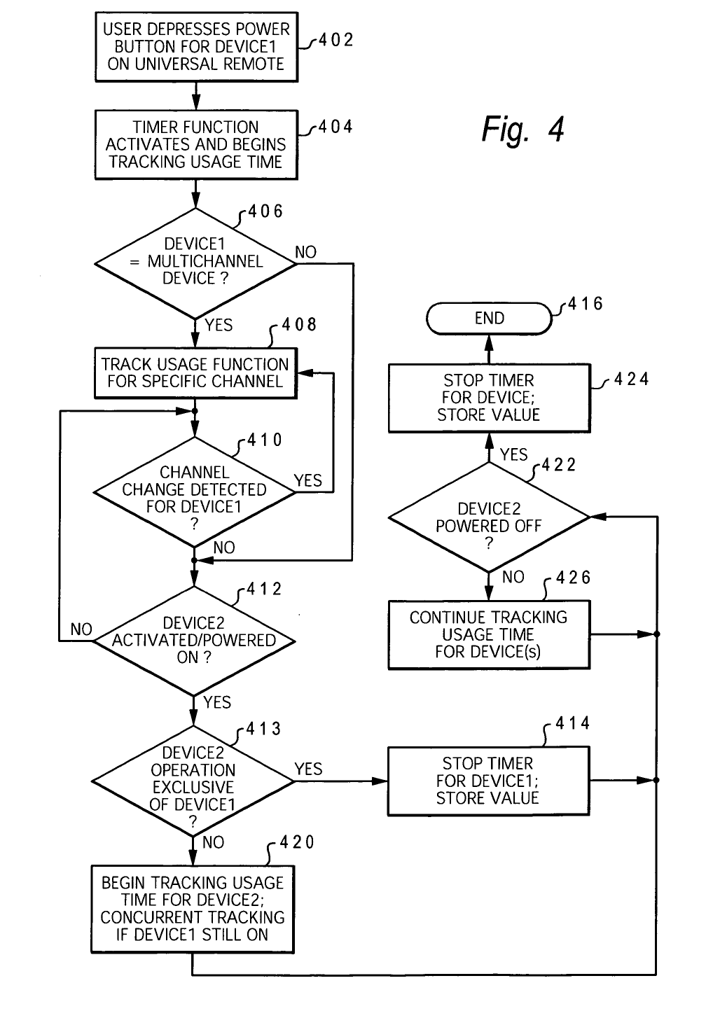

Turning now to FIG. 4, there is provided a flow chart of the user's interaction with the URC 103. The process begins at block 402 at which the user presses the power button for a first device on URC 103. The UTU is activated and begins tracking usage time for the media device (devicel) as shown at block 404. Whenever the user presses one of several pre-designated trigger buttons on URC 103, the UTU is activated and/or updated to begin monitoring the new device and/or new channel. For example, when that the user selects a power button, the particular device (e.g., DVD, TV, stereo) is registered as “on”, the timer is reset, and the timer is assigned to track the usage time for that media device.

Notably, in one embodiment, the trigger event for activating a timer for a device may be different from the power button. Thus, for example, powering on the DVD player may not be a trigger event, while pressing play on the URC 103 to initiate playing a disk on the DVD player would be a trigger event.

Returning to FIG. 4, a determination is then made at block 406 whether the media device powered on is a multi-channel device. If the device is a multi-channel device, a secondary time usage tracking function is initiated to track the time spent viewing/listening to specific channels on the media device as shown at block 408. With the channel-level tracking feature activated, a determination is made at block 410, whether a change in the channel is detected. When a change in channel is detected, the usage time for the previous channel is stored, the timer is reset, and the timer begins tracking the usage time for the new channel.

Returning now to block 406, when the device is not a multi-channel device, no channel tracking is required and that feature of the UTU is deactivated (or not activated) for the particular device. A next determination is made at block 412 whether another device (device2) is powered on (or activated). If the second device is activated while the first device is on and being tracked, a determination is made at block 413 whether the second device operates exclusive of the first device (i.e., only one device may be tracked at a time as with a VCR and DVD connected to a single television).

If the devices must operate exclusive of each other, the timer for the first device is stopped and the value stored at block 414. If the devices are not exclusive of each other, then a second timer is started to track the usage time for device2 as shown at block 420. The timers thus operate in a concurrent manner to track the usage times for both the first and second device, respectively.

At block 422, a determination is made whether one of the devices is powered off (deactivated), and if so, the timer for the device is stopped and the usage time value stored at block 424. Then the process ends at block 416. Otherwise, the timer(s) continues to record the usage time at block 426 until the device(s) is turned off.

A specific example of this operation is now provided in which a user is watching television and interacting with a DVD player, while the URC 103 has usage time tracking feature activated. The user first powers the TV on, which starts the timer, and then the user changes the channel (by either using the numbers or using the up/down channel button). The new channel number is transmitted to the television, effecting the channel change. The UTU captures this change in channel and sets the state of the timer (which maybe a second timer, in one embodiment) to reflect the channel number associated with the device identifier (ID) (e.g., TV>03). Once the channel number is sent to the television, the internal timer of the URC 103 begins counting the elapsed time.

When either the channel button or the power button is pressed on the remote, the timer stops counting for the previous channel (3) and a usage time record is written to memory. This record may include device, channel and time spent (in actual time—hours, minutes, and seconds or blocks of time, e.g., every 5 minutes) as an example. When blocks of time are utilized, a time period less than a full block may be recorded as a fraction of that block of time. Also, a time period less than 5 or 10 seconds (on a channel or media device) may be treated as the user scanning through channels and not recorded within memory of the URC. By using blocks of time, less memory is required for storage of usage time data.

In one embodiment, in addition to sending the amount of time spent watching the particular channel, the actual start time is also provided so that the actual program viewed may be ascertained from the TV guide. This may be used as an indirect monitoring tool, for example, when a parent is away from home and wishes to know what programs a child is actually watching during the time the parent is absent.

The time usage data may be stored as a string of data within the URC 103. For example, that data may be represented as “01>00>15; 02>03>6; 02>37>12; 03>50>11;” where: the first value is the ID of the media device (01—DVD; 02—TV; and 03—stereo (ST)); the second value is the channel, if applicable to the device (00 indicates no channel value); and the third value is the time in 5 minute blocks.

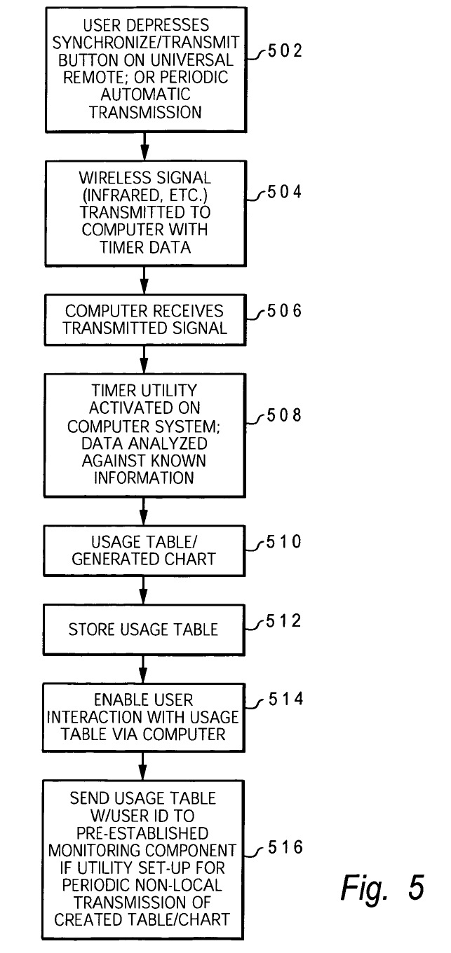

Once the usage time data has been collected, the process of transmitting the data to the computer system is completed as illustrated by the flow chart of FIG. 5. In a first embodiment, the URC 103 includes embedded software for automatically reporting the time usage data on a pre-set period. Alternatively, the user presses the transmit button (or other pre-established buttons to initiate the transmit function of the embedded software) as shown at block 502. The usage time data is transmitted to computer system 300 via wireless signal as shown at block 504. In one embodiment, receiver 320 is an infrared receiving device and the collected data is sent via infrared transmission. The transmitted data stream is similar to the above described example and includes the format of device>channel>time (e.g., DVD>00>15; TV>03>6; TV>37>12; ST>50>11).

At block 506, computer system 300 receives the transmitted data and activates TARU 309 to analyze the data against a set of known parameters as shown at block 508. In one embodiment, TARU 309 processes the received data in the following manner:

(a) For each media device type, (or same device ID), information pertinent to the media device and particular channels are queried via some background mechanism, such as Web Services. For example, for the TV device type, TARU 309 has a channel look-up database that identifies TV channel 3 as FOX, TV channel 37 as Disney, etc. Further, the specific programming at a specific time may be available through an online TV guide.

(b) With the information received from the usage data and other external/background sources, TARU 309 may format a report (in table or chart format, for example), as indicated at block 510. One such report may group together total time spent for each device and channel combination. Other reports may be provided in different formats, which format may be selected by the user for viewing specific data. Among these formats are (1) the top 5 channels watched by time and (2) a pie chart which shows what media devices are used the most, etc.

Table I below illustrates an exemplary report format for television watching and stereo listening between 2:00 PM and 6:00 PM. The time totals are provided in 5 minute blocks.

TABLE I

| DEVICE | TIME | | | TOTAL |
|---|---|---|---|---|
| TV | 2:00-5:00 | | | 36: 3.0 hrs |
| DVD | | 4:00-5:30 | | 18: 1.5 hrs |
| STEREO | | | 5:30-6:00 | 06: 0.5 hrs |

Table II illustrates the breakdown for television watching between 2:00 PM and 5:00 PM. The channels watched are provided in this report format. Notably, actual time in minutes is provided in this presentation format.

TABLE II

| CHANNELS | TIME (PM) | Network | Program | TOTAL |
|---|---|---|---|---|
| 10 | 2:00-3:00 | Cartoon Net | Care Bears | 60 minutes |
| 03 | 3:00-3:35 | ABC | Oprah | 35 minutes |
| 37 | 3:35-5:00 | HBO | Movie | 85 minutes |

Returning to FIG. 5, once the reports are created, the reports are stored within the memory of computer system 300 at block 512, and then the user is able to later view and interact with the data provided within the stored reports, as shown at block 514. Also, in the illustrated embodiment, the report is automatically transmitted to a pre-established, higher-level monitoring device along with a particular ID of the owner/primary user of the URC, at block 516. The monitoring facility may be interconnected to the computer system via a network (LAN or WAN) and may utilize the usage time information to generate statistical usage data across multiple users.

The amount of time spent interacting with particular media devices may be important statistic to record, and the invention contemplates multiple applications for the above described functionality. Among the applications is a parental monitoring application for parents who desire to track what media devices their children interact with at certain period of the day, e.g., during the afternoons after school. These parents may wish to know how much time is actually spent interacting with a particular device, and which specific channel(s) is being accessed (i.e., watched or listened to) while they are away. Likewise a media company may desire to track user accesses to specific media programs (channels watched, etc.) and may utilize the features provided by the invention to receive this information from subscribed users.

The present invention provides a method and URC design by which usage time data is tracked and stored during actual user operation of the URC. The invention further enables the generation of a report of this utilization in a non-intrusive manner. By embedding a background usage time tracking feature in the common URC, which has become a required ‘appliance” for most people while interacting with various media devices, the tracking and reporting functions are completed in an autonomic manner. Only the initial user setup of the URC is required, and in one embodiment, the URC is defaulted to automatically track the time usage data.

As a final matter, it is important that while an illustrative embodiment of the present invention has been, and will continue to be, described in the context of a fully functional computer system with installed management software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention. For example, while transmission between URC and computer system is primarily described as a wireless transmission, the invention contemplates a wired connection between URC and computer system and extends the features described to such an embodiment.

What is claimed is:

1. A remote controller (RC) comprising:
means for initiating an interaction by a user with a first media device;
an internal timing mechanism that tracks a time spent by the user interacting with the first media device; and
means for outputting a record of the time spent by the user interacting with the first media device.

2. The RC of claim 1, wherein:
said means for initiating the interaction comprises at least one selectable button on the RC; and
wherein said RC further comprises:
means for ending an interaction by the user with the first media device; and
a memory component for recording the time spent by the user interacting with the first media device.

3. The RC of claim 2, wherein the means for ending the interaction comprises:
means for stopping the timing mechanism responsive to the interaction being ended; and
means for storing the elapsed time along with an identification (ID) of the first media device.

4. The RC of claim 2, wherein the first media device is one of multiple media devices, said RC further comprising means for tracking a second time period spent interaction with a second media device, wherein:
when the second media device operates at mutually exclusive time periods with the first media device, said internal timing mechanism automatically stops tracking the time period of the first media device and begins tracking the second time period during which the user interacts with the second media device; and
when the second media device does not operate at mutually exclusive time periods with the first media device, said internal timing mechanism continues tracking said time of the first media device and begins tracking the second time period during which the user interacts with the second media device.

5. The RC of claim 1, further comprising means for entering a user code while said at least one selectable button is being pressed, wherein said user code activates the internal timing mechanism prior to the interaction by said user.

6. The RC of claim 1, further comprising:
a mechanism for changing a channel on the first media device;
means, wherein said timing mechanism tracks time spent by the user on each individual channel selected by the user on the first media device; and
wherein the output means outputs a record containing a value of each of the time associated with a specific one of the individual channels selected by the user.

7. The RC of claim 1, further comprising:
timer tracking logic that periodically triggers said output means to output the timer values; and
activation logic for activating a timer tracking feature of the RC to begin tracking user time spent on the media device.

8. The RC of claim 1, wherein the output means includes:
a transmit button that activates the transmission of said usage time values from the RC; and
a transmitter that transmits said usage time values to a receiving unit of an end-node/output device.

9. The RC of claim 8, wherein the transmitter is a wireless transmitter from among an infrared (IR) light emitting diode (LED) transmitter, a radio frequency (RF) transmitter, a bluetooth-enabled transmitter, a wireless a/b/g transmitter, and an ultra-wide band frequency transmitter.

10. A system for tracking user time interacting with media devices, said system comprising:
at least one media device;
a remote controller (RC) that remotely controls an activation of said at least one media device, said controller having:
means for initiating an interaction by a user with a first media device of the at least one media device;
a timer that tracks a time spent by the user interacting with the first media device; and
means for outputting a record of the time spent by the user interacting with the first media device.

11. The system of claim 10, further comprising:
a computer system having a wireless receiver and a processor with code executed thereon for analyzing user time spent on said at least one media device;
wireless transmission mechanism for transmitting the elapsed time and other related data to the receiver of the computer system; and
wherein the controller transmits the elapsed time and other related data to the receiver of the computer system, which forwards the elapsed time and related data to the processor for utilization within the code to generate an output in pre-programmed format.

12. The system of claim 10, wherein the RC further comprises:
means for ending an interaction by the user with the first media device;
means for stopping the timing mechanism responsive to the interaction being ended;
a memory component for recording the time spent by the user interacting with the first media device; and
means for storing the elapsed time along with an identification (ID) of the first media device.

13. The system of claim 12, wherein said RC further comprises means for tracking a second time period spent interaction with a second media device, wherein:
when the second media device operates at mutually exclusive time periods with the first media device, said internal timing mechanism automatically stops tracking the time period of the first media device and begins tracking the second time period during which the user interacts with the second media device; and
when the second media device does not operate at mutually exclusive time periods with the first media device, said internal timing mechanism continues tracking said time of the first media device and begins tracking the second time period during which the user interacts with the second media device.

14. The system of claim 10, further comprising:
activation logic for activating a timer tracking feature of the RC to begin tracking user time spent on the media device; and
means for entering a user code while said at least one selectable button is being pressed, wherein said user code activates the internal timing mechanism prior to the interaction by said user.

15. The system of claim 10, wherein said RC further comprises:
a mechanism for changing a channel on the first media device;
means, wherein said timing mechanism tracks time spent by the user on each individual channel selected by the user on the first media device; and
wherein the output means outputs a record containing a value of each of the time associated with a specific one of the individual channels selected by the user.

16. The system of claim 10, wherein the output means of the RC includes:
a transmit button that activates the transmission of said usage time values from the RC; and
a transmitter that transmits said usage time values to a receiving unit of an end-node/output device; wherein, when the transmitter is a wireless transmitter:
said signal is transmitted as a wireless signal from among infrared (IR), radio frequency, blue tooth, wireless a/b/g, and ultra-wide band; and
said RC further comprises timer tracking logic that periodically triggers said output means to output the timer values via said wireless signal; and.

17. The system of claim 10, wherein the RC is a personal device from among a cell phone, a personal digital assistant (PDA), a specially designed universal remote controller (URC), said system further comprising:
a base for docking the remote controller, said base having at least one receptacle for connecting an output port of the controller and a connector that connects to the computer system;
means for downloading the elapse time and related data from the controller via the receptacle, wherein, when said connector is electrically coupled to the computer system and said remote controller is docked on said base said data is transmitted for utilization within an executing program utility on the computer system.

18. A computer program product comprising:
a computer readable medium; and
program code on the computer readable medium for:
activating a timer analysis utility when a trigger is received during receipt of data from an external source identified as a pre-designated remote controller of media devices;
analyzing the data received from the pre-designated remote controller; and
generating a report of the data received; and
outputting the report in a format pre-selected by a user.

19. The computer program product of claim 18, further comprising program code for compiling the data and automatically forwarding the data to an endpoint device connected via a pre-established network connection.

20. A method for recording time spent interacting with media devices via a remote controller, said method comprising:
tracking via a remoter controller equipped with a timer mechanism time spent by a user interacting with a media device utilizing the remote controller;
forwarding the time spent by the user to a computer device along with the identifier of the particular media device interacted with;
triggering the activation of a usage timer analysis utility on the computer device when data about the time spent is received from the remote controller by the computer device;
analyzing, at the computer device, the data received from the remote controller; and
generating a report of the data received; and
when the report is generated for local use by a user of the computer system, outputting the report in a format pre-selected by a user of the computer device; and
when the report is generated for use by a remotely connected computer system connected via a pre-established network connection, compiling the data and automatically forwarding the data to the remotely connected computer system.
